(19) United States
(12) Patent Application Publication
(10) Pub. No.: US 2009/0075495 A1
(43) Pub. Date: Mar. 19, 2009

(54) Socket of semiconductor module

(75) Inventors: Min-Woo Kim, Chungcheongnam-do (KR); Byeong-Ho Park, Chungcheongnam-do (KR); Dong-Ho Shin, Chungcheongnam-do (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/215,528

(22) Filed: Jun. 27, 2008

(30) Foreign Application Priority Data
Sep. 13, 2007 (KR) 10-2007-0093282

(51) Int. Cl. H01R 12/00

(52) U.S. Cl. 439/65

(57) ABSTRACT

A socket of a semiconductor module is provided. The socket of the semiconductor module comprises a pin in the form of a wire having at least one flat plane and at least two round portion.

### CROSS-REFERENCE TO RELATED APPLICATION

This application claims priority from Korean Patent Application No. 10-2007-0093282 filed on Sep. 13, 2007 in the Korean Intellectual Property Office, the contents of which are incorporated herein by reference in their entirety.

### BACKGROUND OF THE INVENTION

1. Field of the Invention

The present invention relates to a socket of a semiconductor module.

2. Description of the Related Art

In the manufacturing of semiconductor circuit devices, after wafer fabrication and packaging, multiple chips are mounted on a circuit board to be electrically connected to each other. As such, a plurality of semiconductor chips is mounted on a circuit board to operate as an electric device, which is referred to as a semiconductor module.

For example, a semiconductor memory module generally includes 8 semiconductor chips or a multiple of 8 semiconductor chips. It is often the case that a semiconductor memory module may be assembled by 8+1 or (a multiple of 8)+1 semiconductor chips by including a control chip. The semiconductor memory module assembled in this fashion is mounted in an electronic product such as a computer or the like.

Aside from the above-mentioned semiconductor memory device, a variety of semiconductor modules, including logic devices, combined chip semiconductor devices having logic devices and memory devices packaged therein, and so on, have been proposed. Such a variety of semiconductor modules are assembled on a circuit board to comply with various dimensions and standards in accordance with specific purposes and functions.

A conventional socket of a semiconductor module is illustrated in FIG. 1, which is a diagram illustrating an exemplary conventional socket of a semiconductor module. Referring to FIG. 1, the conventional semiconductor module socket has a plurality of pins 10 supported by an elastomeric rubber packing 20. The semiconductor module is inserted downward.

When the semiconductor module is inserted downward, the respective pins 10 are stretched out in a direction indicated by “A” so that the semiconductor module is inserted, and they are forced downward, i.e., in a direction indicated by “B”.

The force in the “A” direction is a restoration force applied by the elastomeric rubber packing 20, so that a tab of the semiconductor module comes into contact with the pins 10 of the socket.

In addition, the socket comes into contact with a circuit board in the “B” direction and is physically and electrically connected to a load board contact of the circuit board. Here, portions of the socket contacting the load board contact are easily worn out.

Due to repeated operations of inserting and withdrawing the semiconductor module into and from the conventional semiconductor module socket, various portions of the semiconductor module socket may be worn out or deformed, making it difficult to achieve intended purposes of the semiconductor module socket. In detail, since portions of the pins 10 contacting with tabs of the semiconductor module are worn out and forces applied to the pins 10 are different according to locations of the contact portions, the elastomeric rubber packing 20 deforms, so that the pins 10 may not contact the tab of the semiconductor module in a uniform manner.

In addition, since the pins 10 are incapable of moving up and down, that is, incapable of controlling or restoring vertical displacements, damage may be caused to the circuit board contacting the pins 10, thereby making the pins 10 sway without being fixed at vertical displacements. In such a case, the pins 10 may not be electrically connected with the load board contact.

In addition, a distance between a portion of the tab of the semiconductor module contacting the pin 10 and the load board contact is greater than or equal to 7 mm, which is compliant with the widely-used operating frequency in the range of about 1 to 3 GHz. That is, if a semiconductor module operating at a high-speed frequency greater than or equal to 3 GHz is inserted into a semiconductor module socket, signal transmission cannot be properly performed. Thus, in order to use a high-speed operating semiconductor module, the distance between the portion of the tab of the semiconductor module contacting the pin 10 and the load board should be shortened so as to be suitable for high-speed operation. However, since the semiconductor module is not readily modified or reformed, a new advanced semiconductor module should be used.

In a socket of a semiconductor module, which is a modified exemplary socket of that shown in FIG. 1, pins have different lengths, which may reduce a physical force applied to the respective pins. However, constructing the pins having different lengths does not make it necessarily possible to maintain a uniform distance between a portion of a tab of the semiconductor module contacting each of the pins and a load board contact. Thus, a semiconductor module operating at high speed cannot be inserted into the socket.

In a socket of a semiconductor module having L-shaped pins, a physical force applied to the pins in a vertical direction cannot be reduced, which may result in poor durability and service life of the socket. Further, other conventional semiconductor module sockets, which cannot reduce a physical force and displacement applied to pins in a vertical direction, have poor durability and a lower service life.

If a physical force applied to pins in a horizontal direction is not properly absorbed or dispersed, an outer coating of the pin 10 may be damaged. The damaged outer coating decreases the ionic conductivity of the pin 10, thereby shortening the service life of the semiconductor module socket.

### SUMMARY OF THE INVENTION

The present invention provides a socket of a semiconductor module that can transmit signals at high speed and has an improved durability.

According to an aspect of the present invention, there is provided a socket of a semiconductor module comprising a pin in the form of a wire having at least one flat plane and at least two round portions.

In one embodiment, at least one of the two round portions is J-shaped or U-shaped.

In one embodiment, the pin further comprises a fixing portion coupled to a housing. In one embodiment, the fixing portion protrudes and is inserted into the housing. In one embodiment, the fixing portion is formed between a first tip of the pin and at least one round portion closest to the first tip. In one embodiment, the fixing portion is formed at the central portion of the pin. In one embodiment, the pin further comprises a second tip of the pin being movable in a predetermined space of the housing. In one embodiment, the pin further comprises a round portion formed between the second tip of the pin and at least one round portion closest to the second tip. In one embodiment, the predetermined space of the housing prevents the second tip of the pin from protruding outside the housing.

In one embodiment, one of the two round portions has a bend angle of greater than or equal to 90°, and the other has a bend angle of less than 90°.

In one embodiment, one of the two round portions is electrically connected to a circuit board. In one embodiment, the other of the two round portions is electrically connected to a tab of the semiconductor module. In one embodiment, the socked further comprises an elastic portion formed on an inner surface of the round portion electrically connected to the circuit board.

According to another aspect of the present invention, there is provided a socket of a semiconductor module comprising a pin in the form of a wire fixed to a housing to prevent vertical movement and having elasticity in a horizontal direction.

In one embodiment, the pin comprises a round portion with a bend angle of greater than or equal to 90°. In one embodiment, the socket further comprises an elastic portion formed on an inner surface of the round portion.

In one embodiment, the pin further comprises a fixing portion coupled to a housing is provided at the central portion of the pin.

In one embodiment, the pin further comprises a fixing portion protruding from a first tip of the pin, the fixing portion being fixed to the housing. In one embodiment, the fixing portion of the pin and a second tip of the pin are positioned in a predetermined space of the housing, and the pin is movable therein. In one embodiment, the predetermined space of the housing prevents the second tip of the pin from protruding outside the housing.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram illustrating an exemplary conventional socket of a semiconductor module.

FIGS. 2A and 2B are a longitudinal sectional views schematically illustrating pins of a socket of a semiconductor module according to an embodiment of the present invention, and connections therebetween.

FIG. 3A is a diagram illustrating a structure before a socket of a semiconductor module according to the present invention is connected to the semiconductor module, and FIG. 3B is a diagram illustrating a structure after the socket of a semiconductor module according to the present invention is connected to the semiconductor module.

### DETAILED DESCRIPTION OF THE INVENTION

Exemplary embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, the regions illustrated in the figures are schematic in nature and their shapes are not intended to illustrate the actual shape of a region of a device and are not intended to limit the scope of the invention.

A socket of a semiconductor module according to the present invention will now be described in detail with reference to the accompanying drawings.

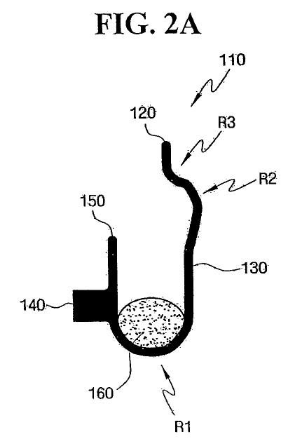

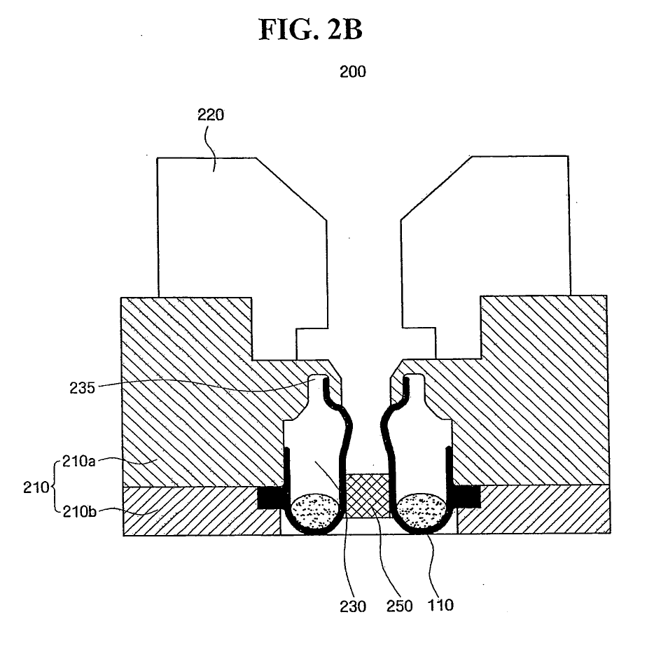

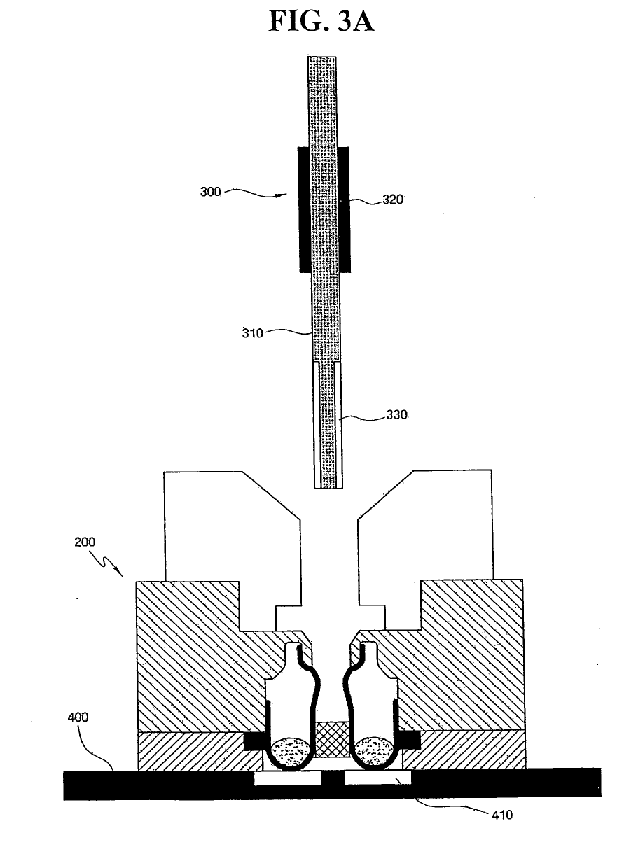

FIGS. 2A and 2B are a longitudinal sectional views schematically illustrating pin of a socket of a semiconductor module according to an embodiment of the present invention and connections therebetween.

Referring to FIG. 2A, a pin 110 of the semiconductor module socket is a J- or U-shaped wire. That is, the pin 110 of the semiconductor module socket has an overall shape of a wire having at least one flat plane and at least two round portions R1 and R2. Throughout the specification of the present invention, the terms “round portion” and “curved portion” can be used interchangeably, and hereinafter, the term “round portion” is to be denoted by R1 and R2.

The pin 110 includes a first tip 120, a body portion 130, a fixing portion 140, and a second tip 150. The pin 110 may further include an elastic portion 160.

The body portion 130 of the pin 110 has at least two round portions R1 and R2. The terms “J-shaped or U-shaped” as used herein refer to the fact that the body portion 130 is curved, so that the pin 110 is self-elastic without elasticity applied from the elastic portion 160.

One of the first and second ends 120 and 150 is closer to the first round portion R1. That is, a length of one of the first and second ends 120 and 150 is relatively smaller compared to the first round portion R1.

The first round portion R1 may include a portion of the pin 110 contacting a circuit board, that is, a load board contact.

Presence of the first round portion R1 establishes stable contacts between the pin 110 and a tab of the semiconductor module when the pin 110 is inserted into the semiconductor module. That is, the elastic portion 160 on an inner surface of the first round portion R1 applies elasticity to the body portion 130 of the pin 110. In addition, even if the pin 110 is applied with a physically large force in a horizontal direction due to the elasticity applied by the elastic portion 160, which may lead to horizontally large displacements, the durability of the pin 110 can be maintained and the pin 110 and the tab of the semiconductor module can be brought into contact in a stable manner. This is because a horizontal force applied to the pin 110 can be efficiently absorbed and dispersed by round portions R1, R2, and R3 of the pin 110 and the elastic portion 160. In one embodiment, the first round portion RI has a bend angle of not less than 90°. In the illustrated example, the bend angle of the first round portion R1 is approximately 180°.

The second round portion R2 may include a portion contacting a tab of the semiconductor module inserted into the semiconductor module socket. Since the second round portion R2 has a curved surface, it intrinsically has elasticity. The elasticity appropriately absorbs or disperses an external impact or a downwardly compressive force. The second round portion R2 has a bend angle of less than 90°.

The third round portion R3 assists the first tip 120 of the pin 110 in being fixed to a housing portion of the semiconductor module socket. The third round portion R3 is not essentially provided but may prevent the pin 110 from being deviated from the semiconductor module socket. Like the second round portion R2, the third round portion R3 has a bend angle of less than 90°.

The fixing portion 140 is coupled to the housing portion of the semiconductor module socket to fix the pin 110. While the current embodiment shows that the fixing portion 140 corresponds to one protruding portion, the invention is not limited thereto. Rather, the fixing portion 140 may correspond to multiple protrusions and may be provided at the second tip 150 of the pin 110. When the fixing portion 140 is provided at the second tip 150 of the pin 110, the pin 110 may further include additional round portion between the first round portion R1 and the second tip 150. Since the pin 110 is fixed by the fixing portion 140, the fixing portion 140 may become a starting point of elasticity. In addition, the fixing portion 140 may control vertical movement of the pin 110. If the vertical movement of the pin 110 is controlled by the fixing portion 140, the pin 110 and the load board contact of the circuit board are not subjected to an excessive physical force, thereby maintaining a stable contact state.

The elastic portion 160 may be formed of elastomeric rubber. The elastic portion 160 can impart elasticity in all directions with respect to the pin 110. In particular, the elastic portion 160 can impart the elasticity in a horizontal direction with respect to the pin 110. That is, the elastic portion 160 imparts horizontal elasticity to the pin 110 in cooperation with the first round portion R1. In addition, the elastic portion 160 may absorb a vertical pressure applied from the load board contact.

In one embodiment, the pin 110 according to the present invention has a surface coated with a highly conductive metal, for example, BeCu alloy. Other materials can be used for the highly conductive metal. The pin 110 may be formed of any kind of a metal irrespective of a single metal or a metal alloy as long as the metal has oxidation resistance, high conductivity and elasticity. For example, the pin 110 may be made of a noble metal. The pin 110 may be self-elastic.

Referring to FIG. 2B, the semiconductor module socket 200 includes a first housing portion 210, a second housing portion 220, a space 230, and a supporting portion 250.

The first housing portion 210 may surround and fix pins 110.

The first housing portion 210 includes the space 230. The space 230 is a space where the pins 110 are positioned, and is larger than a space for the pins 110 so that the pins 110 are elastically movable.

In particular, the socket 200 includes a tip space 235 in which the first tip (120 of FIG. 2A) of the pin 110 is positioned and movable. When the semiconductor module is inserted into the socket 200, the first tip 120 is moved in the tip space 235 left and right.

In addition, the tip space 235 allows the pin 110 to be kept at a connection state with the first housing portion 210. That is, the tip space 235 prevents the pin 110 from being deviated from the first housing portion 210 by restricting movement of the first tip 120 of the pin 110.

The first housing portion 210 may provide the pin space 230 or a space into which the fixing portion 140 of the pin 110 can be inserted and fixed. In order to maintain the fixing portion 140 of the pin 110 in the connection state, the first housing portion 210 may include an upper portion 210a and a lower portion 210b.

The second housing portion 220 is capable of forming a path into which the semiconductor module is inserted. In addition, the second housing portion 220 is capable of fixing the inserted semiconductor module without being swayed.

The supporting portion 250 indicates a termination point of an end of the semiconductor module inserted into the socket 200. The supporting portion 250 will be described below in more detail.

Since the pin 110 according to the present invention does not have a horizontal force applied severely, the coating on the pin suffers less damage than conventional pins. Thus, the durability of the pin 110 is improved and the service life of the socket 200 is enhanced.

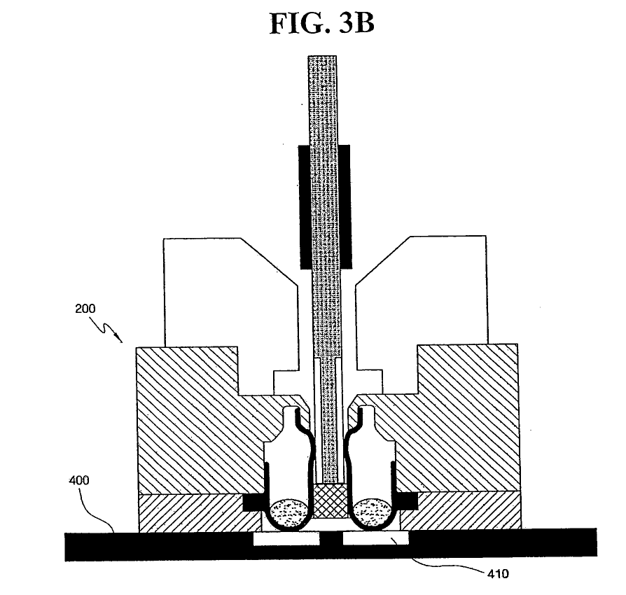

FIG. 3A is a diagram illustrating a structure before a semiconductor module socket 200 according to the present invention is connected to a semiconductor module 300.

Referring to FIG. 3A, the semiconductor module socket 200 is fixed on a circuit board 400, and pins come into contact with load board contacts 410.

The semiconductor module 300 includes a plurality of semiconductor chips 320 and a plurality of tabs 330 on a module board 310.

The plurality of semiconductor chips 320 may be assembled in the semiconductor module 300 such that they are attached to one or both surfaces of the module board 310. The plurality of tabs 330 are electrically connected to the plurality of semiconductor chips 320.

FIG. 3B is a diagram illustrating a structure after the semiconductor module socket 200 according to the present invention is connected to the semiconductor module 300.

Here, in the illustrated exemplary embodiment, a distance between a contact point of each of the tabs 330 of the semiconductor module 300 and the pin 110 of the semiconductor module socket 200 and each of the load board contacts 410 is about 3.5 mm, which has signal transmission efficiency of more than 2 times that of the conventional semiconductor module socket in which a distance between a portion of the tab of the semiconductor module contacting the pin 10 and the load board contact is in a range of 7 mm to 15 mm. That is, while the conventional semiconductor module socket enables signal transmission only at a frequency of 3 GHz or less, the present invention enables signal transmission at a frequency of about 7 GHz.

Since the invention enables signal transmission at high-speed frequency, many kinds of semiconductor module products can be inserted into a semiconductor module socket. That is, the semiconductor module socket according to the present invention can accommodate a variety of products with improved structures and shapes of pins without a need for a special semiconductor module socket customized to high-speed signal transmission in compliance with the standards of high-speed operating semiconductor modules. The semiconductor module according to the present invention has pins with decreased amounts of metal and excellent durability.

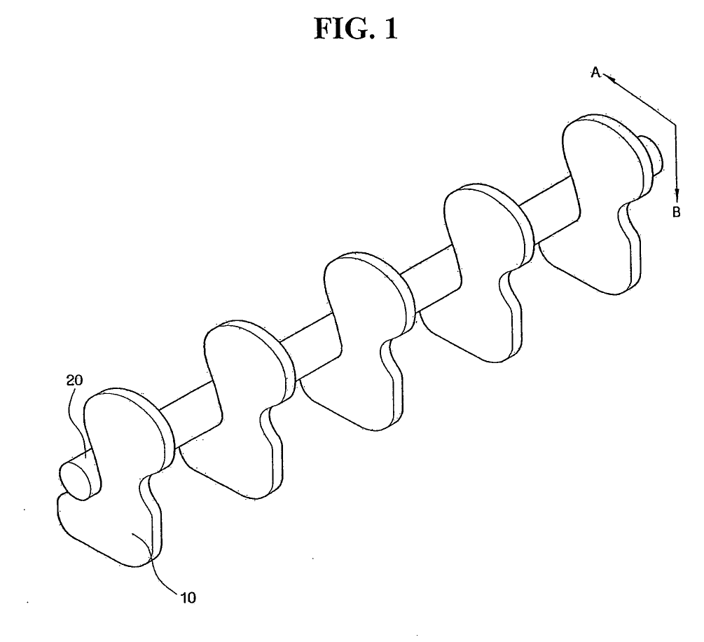

In the pin-shaped, conventional semiconductor module socket shown in FIG. 1, the horizontal pressure applied to each pin was about 166 g, and the horizontal displacement of the pin was about 0.15 mm. However, the semiconductor module socket according to the present invention has a horizontal pressure of about 23 g applied to each pin, and a horizontal displacement of about 0.2 mm. That is, according to the present invention, since the horizontal pressure is small, the durability of the semiconductor module socket is good. In contrast, since the horizontal displacement in the semiconductor module socket is large, the pin and the tab are brought into contact in a stable manner.

The semiconductor module sockets according to exemplary embodiments of the present invention can be fabricated at low cost and enable high-speed signal transmission while having excellent durability. In particular, the semiconductor module socket can be advantageously used for equipment such as a semiconductor module tester which undergoes frequent insertion and removal of semiconductor modules.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A socket of a semiconductor module comprising a pin in the form of a wire having at least one flat plane and at least two round portions.

2. The socket of claim 1, wherein at least one of the two round portions is J-shaped or U-shaped.

3. The socket of claim 1, wherein the pin further comprises a fixing portion coupled to a housing.

4. The socket of claim 3, wherein the fixing portion protrudes and is inserted into the housing.

5. The socket of claim 3, wherein the fixing portion is formed between a first tip of the pin and at least one round portion closest to the first tip.

6. The socket of claim 3, wherein the fixing portion is formed at the central portion of the pin.

7. The socket of claim 3, wherein the pin further comprises a second tip of the pin being movable in a predetermined space of the housing.

8. The socket of claim 7, wherein the pin further comprises a round portion formed between the second tip of the pin and at least one round portion closest to the second tip.

9. The socket of claim 7, wherein the predetermined space of the housing prevents the second tip of the pin from protruding outside the housing.

10. The socket of claim 1, wherein one of the two round portions has a bend angle of greater than or equal to 90°, and the other has a bend angle of less than 90°.

11. The socket of claim 1, wherein one of the two round portions is electrically connected to a circuit board.

12. The socket of claim 11, wherein the other of the two round portions is electrically connected to a tab of the semiconductor module.

13. The socket of claim 11, further comprising an elastic portion formed on an inner surface of the round portion electrically connected to the circuit board.

14. A socket of a semiconductor module comprising a pin in the form of a wire fixed to a housing to prevent vertical movement and having elasticity in a horizontal direction.

15. The socket of claim 14, wherein the pin comprises a round portion with a bend angle of greater than or equal to 90°.

16. The socket of claim 15, further comprising an elastic portion formed on an inner surface of the round portion.

17. The socket of claim 14, wherein the pin further comprises a fixing portion coupled to a housing is provided at the central portion of the pin.

18. The socket of claim 14, wherein the pin further comprises a fixing portion protruding from a first tip of the pin, the fixing portion being fixed to the housing.

19. The socket of claim 18, wherein the fixing portion of the pin and a second tip of the pin are positioned in a predetermined space of the housing, and the pin is movable therein.

20. The socket of claim 19, wherein the predetermined space of the housing prevents the second tip of the pin from protruding outside the housing.
